(19) United States
(12) Patent Application Publication
(10) Pub. No.: US 2018/0360108 A1
(43) Pub. Date: Dec. 20, 2018

(54) LIGHTER-INTEGRATED CIGARETTE CUTTING DEVICE

(71) Applicant: CLEARSITE, LLC, Bethel, CT (US)

(72) Inventor: Charles KING, Jr., Bethel, CT (US)

(21) Appl. No.: 16/060,942

(22) PCT Filed: Dec. 11, 2016
(86) PCT No.: PCT/US16/66039

§ 371 Date: Jun. 9, 2018

Related U.S. Application Data
(60) Provisional application No. 62/265,590, filed on Dec. 10, 2015.

(51) Int. Cl. A24F 13/26; A24F 3/00; A24F 7/00; B67B 7/16; A45D 34/00; F23Q 2/32; B26B 11/00; F41H 9/10

(52) U.S. Cl. CPC A24F 13/26; A24F 3/00; A24F 7/00; B67B 7/16; A45D 2200/057; F23Q 2/32; B26B 11/00; F41H 9/10; A45D 34/00

(57) ABSTRACT

The present invention relates to a cigarette cutting device, comprising: a casing; a cavity within the casing configured to fit onto a lighter; a hole extending through the casing configured to allow an inserted cigarette to pass through an interior space of the hole; a cutting blade configured to extend into the interior space of the hole; and a push button; wherein the push button may actuate the cutting blade to extend into the interior space of the hole to cut the inserted cigarette.

### CROSS-REFERENCE TO RELATED APPLICATIONS

This application claims priority to U.S. Provisional Application No. 62/265,590, filed Dec. 10, 2015, which is hereby incorporated by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates generally to a cigarette cutting device which incorporates a cutting mechanism housed in a casing that may be configured to fit onto the end of a lighter. This invention relates generally to a cigarette cutting device and method which incorporates a cutting assembly housed in a casing that may be configured to fit onto the end of a lighter, and may be used to cut the lit or unlit end off of a partially smoked cigarette, and store the unused portion of the cigarette for later use. Cigarette smokers are often confined to smoke in strictly enforced designated areas—typically an area outside of and a certain required distance away from a building—to enjoy a cigarette break. More often than not, this area is uncovered subjecting the smoker to rain, snow or other elements that may cause discomfort during the cigarette break. Moreover, smoking breaks are often time-limited; for example, a smoker taking a smoking break during working hours may only be able to be away from her desk for a short period of time due to her work obligations. Due to these and many other difficulties, smokers will often discard a cigarette that is only partially smoked, in large part because the smoker is uncomfortable extinguishing the cigarette and putting the previously lit cigarette back into the pack of fresh cigarettes.

By way of example, if a smoker is taking a break on a particularly cold and rainy day, or is expecting an important call, she may not want to risk fire or personal injury by physically tearing and removing the glowing cherry of the lit end of a partially smoked cigarette with her hands, or otherwise cleanly extinguishing it by gently dragging it across or pressing it into a hard non-flammable surface. Simply put, it is difficult to safely extinguish, and ensure that a cigarette is safely extinguished, without risking physical harm and/or destroying the unused portion of the cigarette. Thus, given no way of safely and cleanly extinguishing and saving the unused portion of the cigarette for later use, she would be forced to discard it. As such, it is very common to observe partially smoked extinguished cigarettes in refuse containers located in designated smoking areas. Many of these cigarettes are less than half burnt before they are extinguished, destroyed, and discarded.

With the price of cigarettes increasing exponentially in recent years, many smokers would prefer to save partially smoked cigarettes for later use. Saving partially smoked cigarettes could save some smokers hundreds of dollars per year. Moreover, the ability to smoke a cigarette in parts—e.g., one half on one smoke break, and the other half on a later break—could help people who are trying to cut down on their cigarette usage do so without the undue waste of discarding partially smoked cigarettes.

There is a heartfelt need in the market for a way of safely cutting, saving, and storing partially smoked cigarettes so that they can be finished later. It has been found that an operational cigarette cutter that is portable, lightweight, durable, and easy to use can provide a way for smokers to safely and cleanly extinguish and save a partially smoked cigarette for later use.

### BRIEF SUMMARY OF THE INVENTION

In an embodiment of the present invention, a cigarette cutting device, comprising: a casing; a cavity within the casing configured to fit onto a lighter; a hole extending through the casing configured to allow an inserted cigarette to pass through an interior space of the hole; a cutting blade configured to extend into the interior space of the hole; and a push button; wherein the push button may actuate the cutting blade to extend into the interior space of the hole to cut the inserted cigarette.

In another embodiment of the present invention, the cigarette cutting device further comprising: a canister; a trigger; a lock; a power source; a contact; and, an audio alarm; wherein the contact is in electronic communication with the power source; wherein the power source is in electronic communication with the audio alarm; wherein the power source is in electronic communication with the trigger; wherein the canister contains a substance; wherein the lock is removable attached to the casing; and, wherein when the lock removed from the casing, the trigger activates the power source and the power source activates the audio alarm to produce sound.

In yet another embodiment of the present invention, the substance is a self defense spray.

In another embodiment of the present invention, the cigarette cutting device further comprising: a bottle opener; and, a light; wherein the power source is in electronic communication with the light; and wherein when the lock is removed from the casing, the trigger activates the power source and the power source activates the light to shine.

In yet another embodiment of the present invention, the cigarette cutting device further comprising: a canister; a trigger; a lock; a power source; a contact; and, a light; wherein the contact is in electronic communication with the power source; wherein the power source is in electronic communication with the light; wherein the power source is in electronic communication with the trigger; wherein the canister contains a substance; wherein the lock is removably attached to the casing; and, wherein when the lock is removed from the casing, the trigger activates the power source and the power source activates the light to shine.

In another embodiment of the present invention, the substance is a self defense spray.

In yet another embodiment of the present invention, the cigarette cutting device further comprising: a bottle opener.

In another embodiment of the present invention, the cigarette cutting device comprising: a canister; a lock; a power source; a contact; a bottle opener; a pump adapter; and, a light; wherein the contact is in electronic communication with the power source; wherein the power source is in electronic communication with the light; wherein the push button may actuate the cutting blade to touch the contact and the light is activated to shine; wherein the canister contains a substance; wherein the lock may be in a first position or a second position; wherein when the lock is in the first position, the pump adapter may be actuated to depress the canister to release the substance; and, wherein when the lock is in the second position, the pump adapter may not be actuated to depress the canister to release the substance.

In yet another embodiment of the present invention, the substance is sanitizer.

In another embodiment of the present invention, the substance is breath spray.

In yet another embodiment of the present invention, the cigarette cutting device further comprising: a compartment; a compartment cap; a power source; a contact; a bottle opener; a saw; and, a light; wherein the contact is in electronic communication with the power source; wherein the power source is in electronic communication with the light; wherein the push button may actuate the cutting blade to touch the contact and the light is activated to shine; and, wherein the compartment cap may be in an open position or a closed position.

In another embodiment of the present invention, the cigarette cutting device further comprising: a bowl; an air flow tube; a stem; a mouthpiece; a power source; a contact; a bottle opener; and, a light; wherein the contact is in electronic communication with the power source; wherein the power source is in electronic communication with the light; wherein the push button may actuate the cutting blade to touch the contact and the light is activated to shine; wherein the bowl, the airflow tube, the stem and the mouthpiece are configured to allow the passage of air from the bowl through the air flow tube, through the stem and to the mouthpiece; and, wherein the bowl is configured to hold a smoking substance.

In yet another embodiment of the present invention, the cigarette cutting device further comprising: a razor; wherein, the razor is removably attached to the casing.

Embodiments of the cigarette cutter may be shaped, formed or configured to be attached to any size, shape, or model of cigarette lighter. For example, some cigarette cutters may be configured to have an oval cavity in which a standard sized and shaped branded lighter having a plastic oval body may be placed. In some embodiments, the lighter may be affixed to the cavity of the cigarette cutter, for example, by way of glue, double-sided tape, or velcro.

Some embodiments of the cigarette cutter may include a casing comprising a hole that optionally extends through the casing. In some embodiments, this hole may be configured to accept the lit or unlit end of a cigarette, which can be passed through the hole so that the ends of the cigarette extend from each side of the cigarette cutter. This hole may be any size and shape, but is preferably shaped and sized so that the cigarette fits and easily slides through the hole.

The casing of the cigarette cutter may further comprise a blade that can be used to cut a cigarette. In some examples, the blade may be spring loaded and may be actuated by a push button. In some embodiments, pushing the push button may actuate the blade which may be configured to extend into the internal space of the hole, and cut through an inserted cigarette. In one or more embodiments, the actuated blade may cleanly slice a lit cigarette that is inserted into the hole, effectively removing the glowing cherry so that the remainder of the now extinguished cigarette can be removed from the hole and safely stored for later use.

Some embodiments of the cigarette cutter may include other features or functions, including without limitation: (i) a hollow cavity in which to place and store a partially smoked cigarette; (ii) a bottle opener; (iii) a light emitting diode (LED) light; (iv) a whistle; and/or (v) a casing that is adaptable to fit lighter of different sizes and dimensions.

In one or more embodiments, the cutting blade may be incorporated into the hollow cavity used to store a cigarette. For example, a hollow cavity for storing the cigarette may comprise a spring loaded cigarette cutting blade that serves a secondary function to form an enclosed base of the hollow cavity. In some embodiments, the blade may be actuated, for example via a push button, into an open position so that a lit cigarette may be inserted into the hollow cavity and the lit end may be extended through the now open base of the of the hollow cavity. The push button may then be released allowing the blade to extend back into the hole functioning to (i) cut the cigarette and release the hot cherry, and (ii) form the enclosed base of the hollow cavity to hold and allow for safe storage of the unused portion of the cigarette. The cutting blade may also cut an unlit end of a cigarette.

### BRIEF DESCRIPTION OF THE SEVERAL VIEWS OF THE DRAWING

An understanding of embodiments described herein, and many of the attendant advantages thereof may be readily obtained, by reference to the detailed description when considered with the accompanying drawings, wherein:

FIG. 1 depicts an embodiment of cigarette cutting device comprising a hole extending through the cigarette cutter housing, and a push button which, when pushed, actuates a cutting blade which extends through the internal space of the hole and is capable of cutting a cigarette that is inserted into the hole.

FIG. 2 is a top view of an embodiment of the present invention.

FIG. 3 is a side view of an embodiment of the present invention.

FIG. 4 is front view of an embodiment of the present invention.

FIG. 5 is a perspective view of an embodiment of the present invention.

FIG. 6 is a perspective view of an embodiment of the present invention.

FIG. 7 is a perspective view of an embodiment of the present invention.

FIG. 8 is a perspective view of an embodiment of the present invention.

FIG. 9 is a perspective view of an embodiment of the present invention.

FIG. 10 is a perspective view of an embodiment of the present invention.

### DETAILED DESCRIPTION OF THE INVENTION

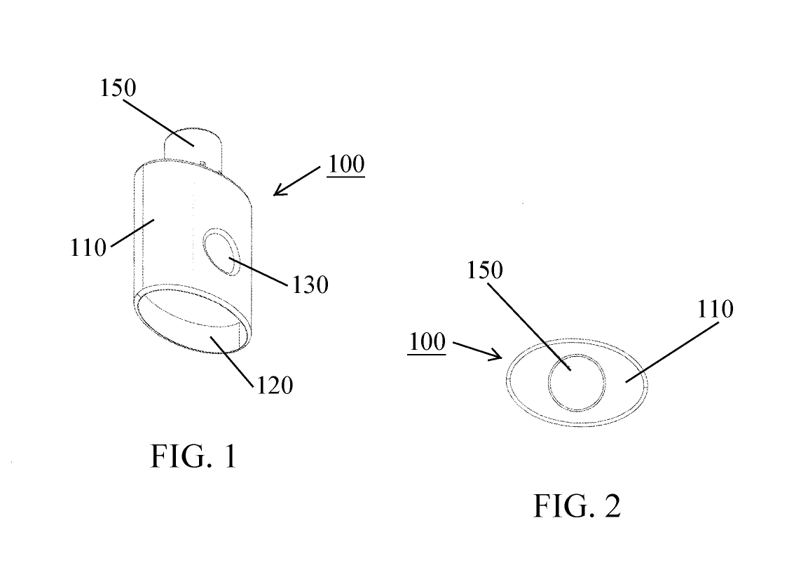

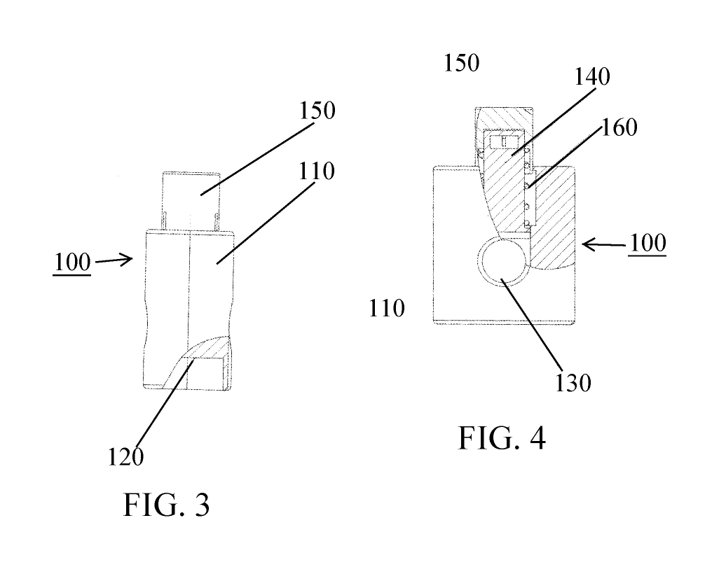

FIGS. 1 through 10 illustrate various embodiments of the present invention. In particular, disclosed is a cigarette cutting device 100 comprising: a casing 110; a cavity 120 within the casing 110 configured to fit onto a lighter 170; a hole 130 extending through the casing 110 configured to allow an inserted cigarette to pass through an interior space of the hole 130; a cutting blade 140 configured to extend into the interior space of the hole 130; and a push button 150; wherein the push button 150 may actuate the cutting blade 140 to extend into the interior space of the hole 130 to cut the inserted cigarette.

FIG. 4 illustrates an embodiment of the present invention with a cut away view showing the actuation of the push button 150 may be facilitated with a spring 160. However, the actuation of the push button 150 is not limited to the spring method, as the actuation may be facilitated by means known to one skilled in the art.

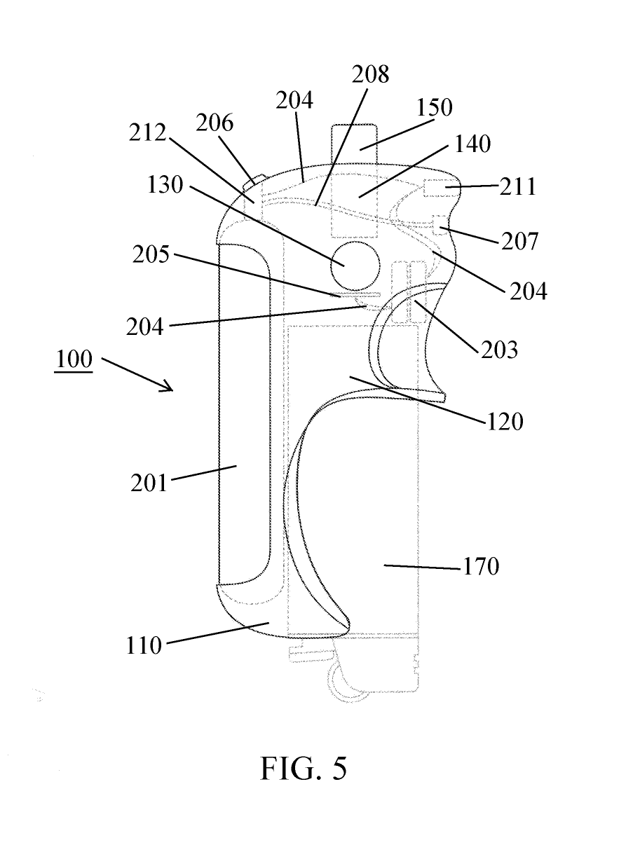

FIGS. 5 through 10 are illustrated with a lighter 170 engaged with various embodiments of the present invention. Although FIGS. 5 through 10 illustrate the lighter 170 with its base inserted into the cigarette cutting device 100, the present invention may be utilized where the top end of the lighter 170 may be inserted into the cigarette cutting device 100. The various embodiments of the present invention can be manufactured to fit lighters 170 of different sizes and shapes. The lighter 170 may be removed and replaced. FIGS. 5 through 8 and FIG. 10 show various embodiments of the present invention having an ergonomic grip. The present invention is not limited to the shapes, sizes and grips illustrated, as the figures are for exemplary purposes.

Referring to FIG. 5, disclosed is an embodiment of the cigarette cutting device 100 comprising: a canister 201; a trigger 212; a lock 206; a power source 203; a contact 205; and, an audio alarm 211; wherein the contact 205 is in electronic communication with the power source 203; wherein the power source 203 is in electronic communication with the audio alarm 211; wherein the power source 203 is in electronic communication with the trigger 212; wherein the canister contains a substance; wherein the lock 206 is removably attached to the casing 110; and, wherein when the lock 206 is removed from the casing 110, the trigger 212 activates the power source 203 and the power source 203 activates the audio alarm 211 to produce sound. With the lock 206 removed from the casing 110, the trigger 212 is exposed and a user may depress the trigger 212 to release the substance from the canister 201. The substance is expelled from the canister 201 through the tube 208 and out the nozzle 207. The electronic communication may be made through wiring 204.

The substance may a liquid, gas, oil, propellant, or aerosol. For example, the substance may be, but is not limited to, self defense sprays, air fresheners, breath sprays, perfumes, and hand sanitizers. Preferably, the substance is a self defense spray. Self defense sprays include, but are not limited to, pepper sprays, tear gas, bear sprays, dog sprays, and other self defense sprays known to one skilled in the art. The canister 201 may be interchangeable to a canister 201 containing a different substance or replaceable with a canister 201 containing the same substance.

Optionally, the cigarette cutting device 100 may further comprise a bottle opener 210; and, a light 202; wherein the power source 203 is in electronic communication with the light 202; and wherein when the lock 206 is removed from the casing 110, the trigger 212 activates the power source 203 and the power source 203 activates the light 202 to shine. The light 202 may be, but not limited to, light emitting diodes (LED), compact fluorescent (CFL) bulb, incandescent bulbs, fluorescent bulbs, halogen bulbs, high-intensity discharge (HID) bulbs, and lasers. The color of the laser may be, but not limited to, red, blue and green. Preferably, a red laser is the light 202 to be used in combination with the self defense spray, to allow more accurate targeting for the self defense spray.

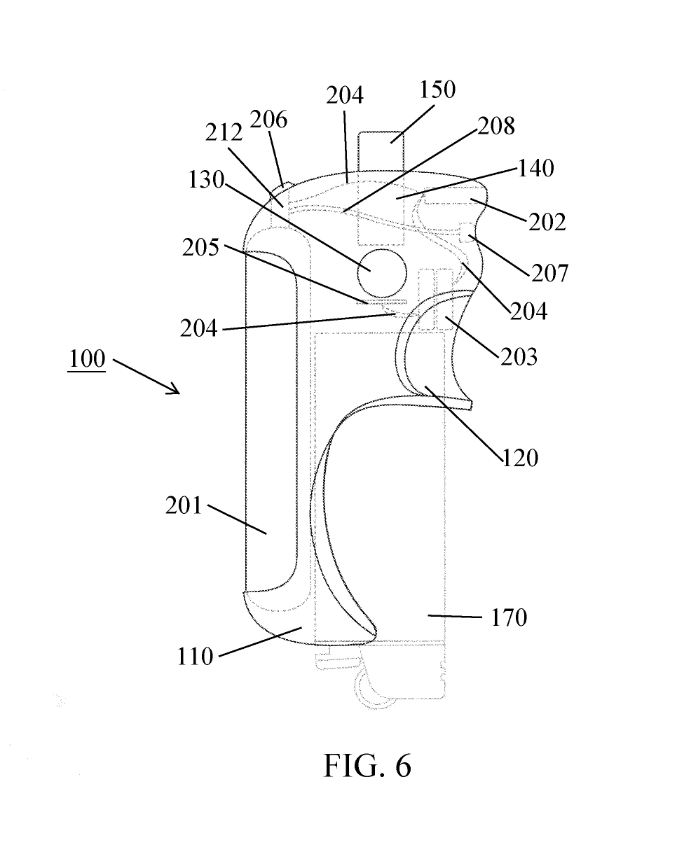

Referring to FIG. 6, disclosed is an embodiment of the cigarette cutting device 100 further comprising: a canister 201; a trigger 212; a lock 206; a power source 203; a contact 205; and, a light 202; wherein the contact 205 is in electronic communication with the power source 203; wherein the power source 203 is in electronic communication with the light 202; wherein the power source 203 is in electronic communication with the trigger 212; wherein the canister 201 contains a substance; wherein the lock 206 is removably attached to the casing 110; and, wherein when the lock 206 is removed from the casing 110, the trigger 212 activates the power source 203 and the power source 203 activates the light 202 to shine. With the lock 206 removed from the casing 110, the trigger 212 is exposed and a user may depress the trigger 212 to release the substance from the canister 201. The substance is expelled from the canister 201 through the tube 208 and out the nozzle 207. The electronic communication may be made through wiring 204.

The substance may a liquid, gas, oil, propellant, or aerosol. For example, the substance may be, but is not limited to, self defense sprays, air fresheners, breath sprays, perfumes, and hand sanitizers. Preferably, the substance is a self defense spray. Self defense sprays include, but are not limited to, pepper sprays, tear gas, bear sprays, dog sprays, and other self defense sprays known to one skilled in the art. The canister 201 may be interchangeable to a canister 201 containing a different substance or replaceable with a canister 201 containing the same substance.

The light 202 may be, but not limited to, light emitting diodes (LED), compact fluorescent (CFL) bulb, incandescent bulbs, fluorescent bulbs, halogen bulbs, high-intensity discharge (HID) bulbs, and lasers. The color of the laser may be, but not limited to, red, blue and green. Preferably, a red laser is the light 202 to be used in combination with the self defense spray, to allow more accurate targeting for the self defense spray.

The cigarette cutting device 100 may further comprise: a bottle opener 210.

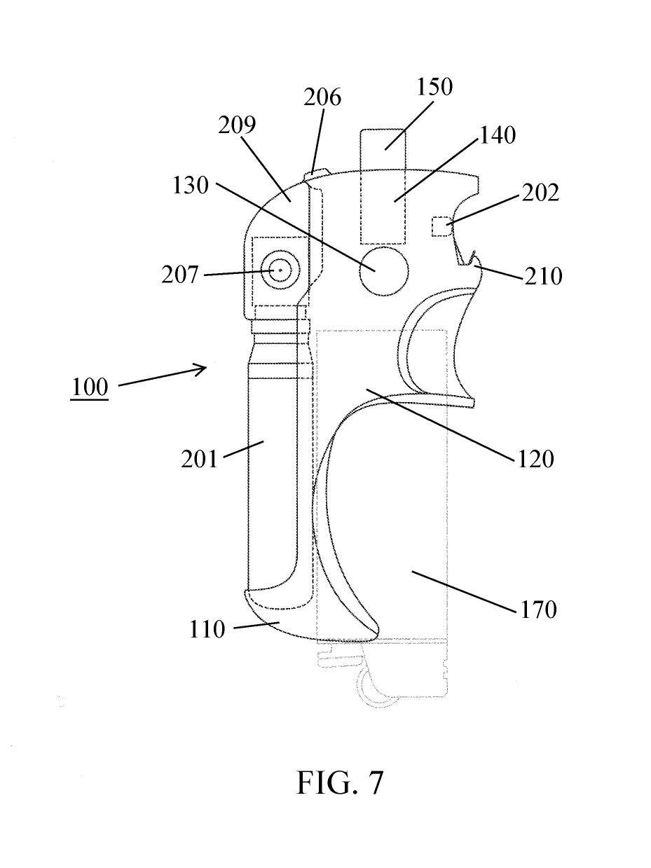

Referring to FIG. 7, disclosed is an embodiment of the cigarette cutting device 100 further comprising: a canister 201; a lock 206; a power source 203; a contact 205; a bottle opener 210; a pump adapter 209; and, a light 202; wherein the contact 205 is in electronic communication with the power source 203; wherein the power source 203 is in electronic communication with the light 202; wherein the push button 150 may actuate the cutting blade 140 to touch the contact 205 and the light 202 is activated to shine; wherein the canister 201 contains a substance; wherein the lock 206 may be in a first position or a second position; wherein when the lock 206 is in the first position, the pump adapter 209 may be actuated to depress the canister 201 to release the substance; and, wherein when the lock 206 is in the second position, the pump adapter 209 may not be actuated to depress the canister 201 to release the substance. When the pump adapter 209 is actuated to depress the canister 201, the substance is expelled from the canister 201 and out the nozzle 207. For clarity purposes, the contact 205, power source 203, and wiring 204 are not illustrated in FIG. 7.

The substance may a liquid, gas, oil, propellant, or aerosol. For example, the substance may be, but is not limited to, self defense sprays, air fresheners, breath sprays, perfumes, and hand sanitizers. Preferably, the substance is a self defense spray. Self defense sprays include, but are not limited to, pepper sprays, tear gas, bear sprays, dog sprays, and other self defense sprays known to one skilled in the art. The canister 201 may be interchangeable to a canister 201 containing a different substance or replaceable with a canister 201 containing the same substance.

The light 202 may be, but not limited to, light emitting diodes (LED), compact fluorescent (CFL) bulb, incandescent bulbs, fluorescent bulbs, halogen bulbs, high-intensity discharge (HID) bulbs, and lasers. The color of the laser may be, but not limited to, red, blue and green. Preferably, an LED is the light 202 to be used in combination with the sanitizer.

An alternative preferred substance is breath spray. Preferably, an LED is the light 202 to be used in combination with the breath spray. The canister 201 may be interchangeable to a canister 201 containing a different substance or replaceable with a canister 201 containing the same substance.

The pump adapter 209 works as an extension of the button of the canister 201. As a result, depressing the pump adapter 209, depresses the button of the canister 201, which releases, expels or sprays the substance.

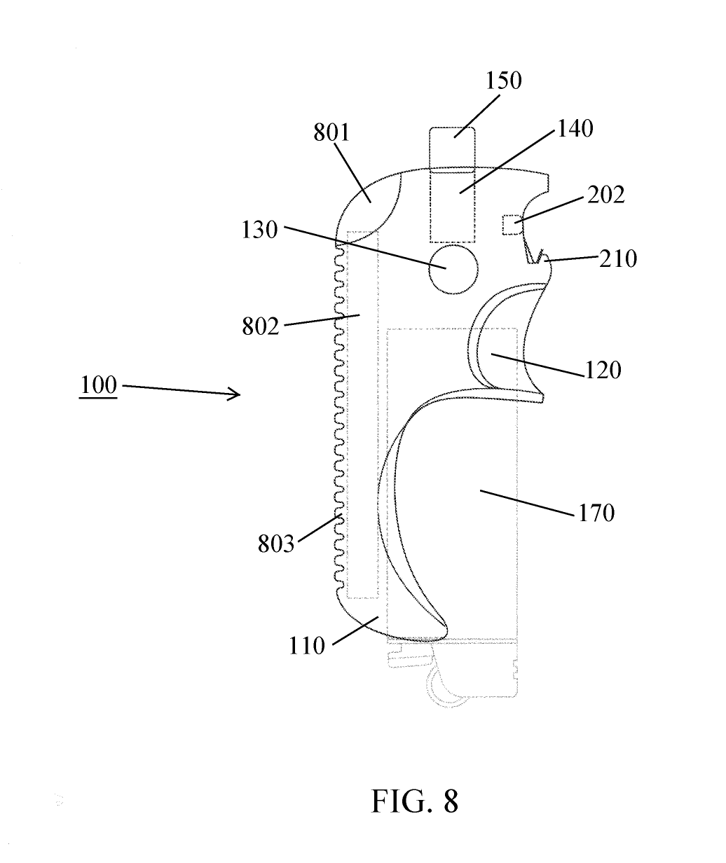

Referring to FIG. 8, disclosed is an embodiment of the cigarette cutting device 100 further comprising: a compartment 802; a compartment cap 801; a power source 203; a contact 205; a bottle opener 210; a saw 803; and, a light 202; wherein the contact 205 is in electronic communication with the power source 203; wherein the power source 203 is in electronic communication with the light 202; wherein the push button 150 may actuate the cutting blade 140 to touch the contact 205 and the light 202 is activated to shine; and, wherein the compartment cap 801 may be in an open position or a closed position. For clarity purposes, the contact 205, power source 203, and wiring 204 are not illustrated in FIG. 8.

The light 202 may be, but not limited to, light emitting diodes (LED), compact fluorescent (CFL) bulb, incandescent bulbs, fluorescent bulbs, halogen bulbs, high-intensity discharge (HID) bulbs, and lasers. The color of the laser may be, but not limited to, red, blue and green. Preferably, the light 202 is an LED.

The compartment 802 may be utilized to store items including, but not limited to, cigarettes, pills, medication, vitamins, matches and money. Preferably, the compartment cap 801 is hinged to allow the compartment cap 801 to be in an open position or a closed position.

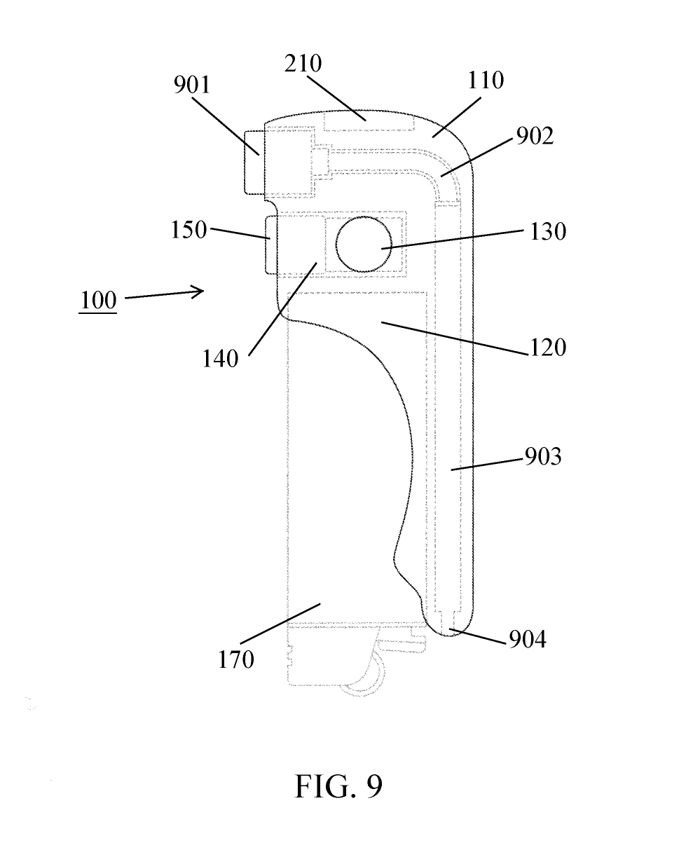

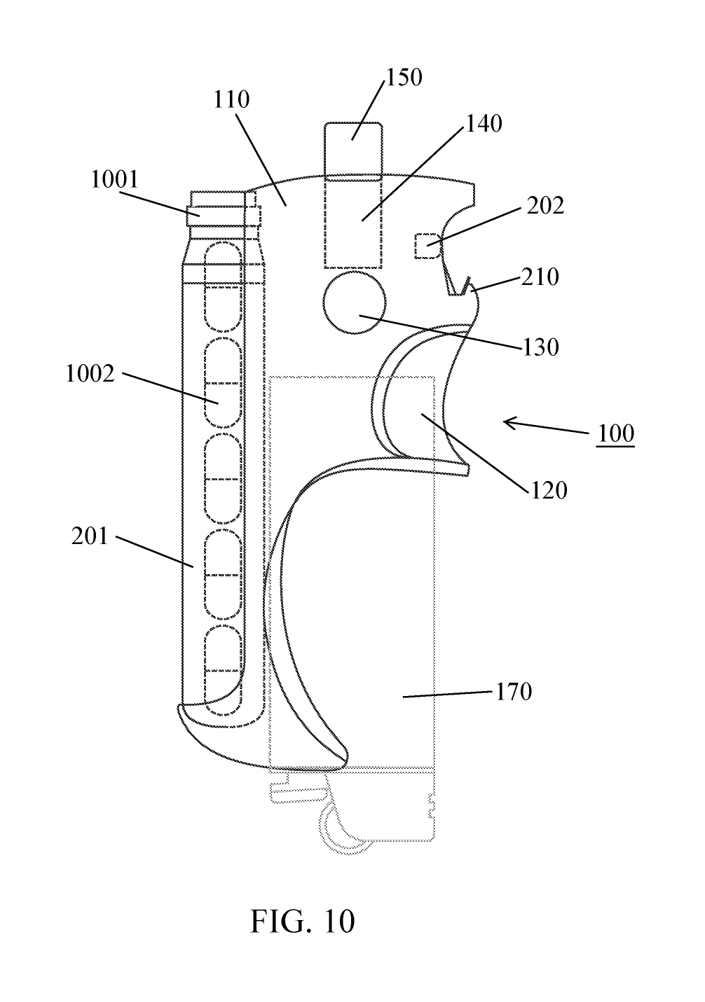

Referring to FIG. 9, disclosed is an embodiment of the cigarette cutting device 100 further comprising: a bowl 901; an air flow tube 902; a stem 903; a mouth piece 904; a power source 203; a contact 205; a bottle opener 210; and, a light 202; wherein the contact 205 is in electronic communication with the power source 203; wherein the power source 203 is in electronic communication with the light 202; wherein the push button 150 may actuate the cutting blade 140 to touch the contact 205 and the light 202 is activated to shine; wherein the bowl 901, the airflow tube 902, the stem 903 and the mouthpiece 904 are configured to allow the passage of air from the bowl 901 through the airflow tube 902, through the stem 903 and to the mouthpiece 904; and, wherein the bowl 901 is configured to hold a smoking substance. For clarity purposes, the contact 205, power source 203, wiring 204, and the light 202 are not illustrated in FIG. 9.

The light 202 may be, but not limited to, light emitting diodes (LED), compact fluorescent (CFL) bulb, incandescent bulbs, fluorescent bulbs, halogen bulbs, high-intensity discharge (HID) bulbs, and lasers. The color of the laser may be, but not limited to, red, blue and green. Preferably, the light 202 is an LED.

The smoking substance may be, but is not limited to, tobacco, marijuana, shisha, kreteks, tobacco mixtures, and other pipe smoking products known to one skilled in the art.

The bowl 901, the airflow tube 902, the stem 903 and the mouthpiece 904 are configured to act as a traditional pipe, where the smoking substance, such as tobacco, is placed into the bowl 901 and lit. The smoke is then drawn through the airflow tube 902, the stem 903 and the mouthpiece 904 and inhaled.

Preferably, the bowl 901 is removably attached. This allows the for easier cleaning. Preferably, the bowl 901 is threaded.

Referring to FIG. 10, disclosed is an embodiment of the cigarette cutting device 100 further comprising: a canister 201; a power source 203; a contact 205; a bottle opener 210; and, a light 202; wherein the contact 205 is in electronic communication with the power source 203; wherein the power source 203 is in electronic communication with the light 202; wherein the push button 150 may actuate the cutting blade 140 to touch the contact 205 and the light 202 is activated to shine; and, wherein the canister 201 is adapted to be fitted with a cap 1001. The canister 201 may be utilized to store items 1002 including, but not limited to, cigarettes, pills, medication, vitamins, matches and money. When the items 1002 are medical capsules or pills or other substances with potential for danger, the cap 1001 is preferably child resistant. For clarity purposes, the contact 205, power source 203, and wiring 204 are not illustrated in FIG. 10.

The light 202 may be, but not limited to, light emitting diodes (LED), compact fluorescent (CFL) bulb, incandescent bulbs, fluorescent bulbs, halogen bulbs, high-intensity discharge (HID) bulbs, and lasers. The color of the laser may be, but not limited to, red, blue and green. Preferably, the light 202 is an LED.

Other embodiments of the cigarette cutting device 100 may further comprise: a razor; wherein, the razor is removably attached to the casing 110.

The term “cigarette” includes, but is not limited to, bidis, cigarettes, cigars, cigarillos, clove cigarettes, little cigars, marijuana, shisha, kreteks and other consumable smoking products known to one skilled in the art.

The present disclosure shows various embodiments having different combinations of functional elements. The present invention encompasses various combinations, not illustrated or described, of functional elements that may be configured by one skilled in the art. For example, an embodiment of the present invention may include more than one light 202, such as, the cigarette cutting device 100 comprising both an LED and a laser.

I claim:

1. A cigarette cutting device, comprising:
a casing;
a cavity within the casing configured to fit onto a lighter;
a hole extending through the casing configured to allow an inserted cigarette to pass through an interior space of the hole;
a cutting blade configured to extend into the interior space of the hole; and
a push button;
wherein the push button may actuate the cutting blade to extend into the interior space of the hole to cut the inserted cigarette.

2. The cigarette cutting device of claim 1 further comprising:
a canister;
a trigger;
a lock;
a power source;
a contact; and,
an audio alarm;
wherein the contact is in electronic communication with the power source;
wherein the power source is in electronic communication with the audio alarm;
wherein the power source is in electronic communication with the trigger;
wherein the canister contains a substance;
wherein the lock is removably attached to the casing; and,
wherein when the lock is removed from the casing, the trigger activates the power source and the power source activates the audio alarm to produce sound.

3. The cigarette cutting device of claim 2, wherein the substance is a self defense spray.

4. The cigarette cutting device of claim 3 further comprising:
a bottle opener; and,
a light;
wherein the power source is in electronic communication with the light; and,
wherein when the lock is removed from the casing, the trigger activates the power source and the power source activates the light to shine.

5. The cigarette cutting device of claim 4 further comprising:
a razor; wherein, the razor is removably attached to the casing.

6. The cigarette cutting device of claim 1 further comprising:
a canister;
a trigger;
a lock;
a power source;
a contact; and,
a light;
wherein the contact is in electronic communication with the power source;
wherein the power source is in electronic communication with the light;
wherein the power source is in electronic communication with the trigger;
wherein the canister contains a substance;
wherein the lock is removably attached to the casing; and,
wherein when the lock is removed from the casing, the trigger activates the power source and the power source activates the light.

7. The cigarette cutting device of claim 6, wherein the substance is a self defense spray.

8. The cigarette cutting device of claim 7 further comprising:
a bottle opener.

9. The cigarette cutting device of claim 8 further comprising:
a razor; wherein, the razor is removably attached to the casing.

10. The cigarette cutting device of claim 1 further comprising:
a canister;
a lock;
a power source;
a contact;
a bottle opener;
a pump adapter; and,
a light;
wherein the contact is in electronic communication with the power source;
wherein the power source is in electronic communication with the light;
wherein the push button may actuate the cutting blade to touch the contact and the light is activated to shine;
wherein the canister contains a substance;
wherein the lock may be in a first position or a second position;
wherein when the lock is in the first position, the pump adapter may be actuated to depress the canister to release the substance; and,
wherein when the lock is in the second position, the pump adapter may not be actuated to depress the canister to release the substance.

11. The cigarette cutting device of claim 10, wherein the substance is sanitizer.

12. The cigarette cutting device of claim 11 further comprising:
a razor; wherein, the razor is removably attached to the casing.

13. The cigarette cutting device of claim 10, wherein the substance is breath spray.

14. The cigarette cutting device of claim 13 further comprising:
a razor; wherein, the razor is removably attached to the casing.

15. The cigarette cutting device of claim 1 further comprising:
a compartment;
a compartment cap;
a power source;
a contact;
a bottle opener;
a saw; and,
a light;
wherein the contact is in electronic communication with the power source;
wherein the power source is in electronic communication with the light;
wherein the push button may actuate the cutting blade to touch the contact and the light is activated to shine; and,
wherein the compartment cap may be in an open position or a closed position.

16. The cigarette cutting device of claim 15 further comprising:
a razor; wherein, the razor is removably attached to the casing.

17. The cigarette cutting device of claim 1 further comprising:
a bowl;
an air flow tube;
a stem;
a mouth piece;
a power source;
a contact;
a bottle opener; and,
a light;
wherein the contact is in electronic communication with the power source;
wherein the power source is in electronic communication with the light;
wherein the push button may actuate the cutting blade to touch the contact and the light is activated to shine;
wherein the bowl, the airflow tube, the stem and the mouthpiece are configured to allow the passage of air from the bowl through the air flow tube, through the stem and to the mouthpiece; and,
wherein the bowl is configured to hold a smoking substance.

18. The cigarette cutting device of claim 17 further comprising:
a razor; wherein, the razor is removably attached to the casing.
